(19) United States
(12) Patent Application Publication
(10) Pub. No.: US 2024/0072439 A1
(43) Pub. Date: Feb. 29, 2024

(54) ANTENNA DEVICE

(71) Applicant: Panasonic Holdings Corporation, Osaka (JP)

(72) Inventor: Naoki ADACHI, Kanagawa (JP)

(21) Appl. No.: 18/457,187

(22) Filed: Aug. 28, 2023

(30) Foreign Application Priority Data
Aug. 31, 2022 (JP) 2022-138108

(51) Int. Cl. H01Q 5/335; H01Q 1/52; H01Q 21/06; H01Q 21/30

(52) U.S. Cl. CPC H01Q 5/335; H01Q 1/523; H01Q 21/061; H01Q 21/30

(57) ABSTRACT

An antenna device includes: a plurality of first antenna electrodes corresponding to a first frequency; and a plurality of second antenna electrodes corresponding to a second frequency lower than the first frequency, wherein each of the first antenna electrodes is disposed at a different one of lattice points at an interval of a half wavelength of the first frequency, and each of the second antenna electrodes is disposed at a different one of lattice points at an interval represented by the formula {(n·d)²+(m·d)²}^{1/2}, where d is the half wavelength of the first frequency, and n and m are positive integers.

### BACKGROUND

### 1. Technical Field

The present disclosure relates to an antenna device.

### 2. Description of the Related Art

Examples of an antenna device used in a multi-band communication system include a phased array antenna in the shape of a flat panel shape. Unexamined Japanese Patent Publication No. 2017-200168 discloses, in FIG. 1, an antenna device including transmission antenna aperture 102 and reception antenna aperture 103 on aperture housing 106 of a phased array antenna that is compatible with two frequencies of a transmission frequency band and a reception frequency band. Unexamined Japanese Patent Publication No. H5-308223 discloses, in FIG. 1, an antenna device including antenna elements 31 corresponding to a first frequency band and being disposed at an interval D1, and antenna elements 32 corresponding to a second frequency band and being disposed at an interval d1, thereby being compatible with two frequency bands.

### SUMMARY

In one general aspect, the techniques disclosed here feature an antenna device compatible with multiple bands that suppresses not only increase in size of the device but also deterioration of antenna characteristics.

An antenna device according to an aspect of the present disclosure includes: a plurality of first antenna electrodes corresponding to a first frequency; and a plurality of second antenna electrodes corresponding to a second frequency lower than the first frequency, wherein each of the first antenna electrodes is disposed at a different one of lattice points at an interval of a half wavelength of the first frequency, and each of the second antenna electrodes is disposed at a different one of lattice points at an interval represented by the formula

{(n·d)²+(m·d)²}^{1/2},

where d is the half wavelength of the first frequency, and n and m are positive integers.

An aspect of the present disclosure suppresses an antenna device compatible with multiple bands from having an increase in size of the device and a deterioration of antenna characteristics.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a partial top view of an antenna device according to a first exemplary embodiment of the present disclosure;

FIG. 2A is a diagram illustrating placement of antenna elements;

FIG. 2B is a diagram illustrating placement of antenna elements;

FIG. 2C is a diagram illustrating placement of antenna elements;

FIG. 3 is a diagram illustrating placement of antenna elements from another viewpoint;

FIG. 4 is a perspective view of a second antenna element;

FIG. 5 is a top view of the second antenna element;

FIG. 6 is a top view of a second antenna element in another exemplary embodiment;

FIG. 7 is a sectional view of an antenna device including an antenna substrate, a high frequency circuit board, and an interposer;

FIG. 8 is a sectional view taken along line VIII-VIII in FIG. 4;

FIG. 9 is an enlarged view of dotted frame IX in FIG. 8;

FIG. 10 is a perspective view of an interposer;

FIG. 11 is a diagram illustrating a modification of the antenna device according to the first exemplary embodiment;

FIG. 12A is a diagram illustrating placement of antenna elements;

FIG. 12B is a diagram illustrating placement of antenna elements;

FIG. 13 is a diagram illustrating placement of antenna elements from another viewpoint;

FIG. 14 is a partial top view of an antenna device according to a second exemplary embodiment of the present disclosure;

FIG. 15 is a diagram illustrating a first modification of the antenna device according to the second exemplary embodiment; and

FIG. 16 is a diagram illustrating a second modification of the antenna device according to the second exemplary embodiment.

### DETAILED DESCRIPTION OF PREFERRED EMBODIMENTS

Prior to description of exemplary embodiments of the present disclosure, problems in a conventional technology will briefly be described. An antenna device disclosed in Unexamined Japanese Patent Publication No. 2017-200168 includes an array antenna for each corresponding frequency band, and thus the antenna device increases in size in proportion to the number of corresponding frequency bands.

In an antenna system disclosed in Unexamined Japanese Patent Publication No. H5-308223, if a frequency of one of two frequency bands is not an integral multiple of the other frequency, the distances between the two types of antenna elements corresponding to each frequency band become uneven, and thus the antenna characteristics such as the frequency characteristics of the gain, the directional characteristics, and the sidelobe characteristics may deteriorate.

Hereinafter, exemplary embodiments of the present disclosure will be described in detail with reference to the drawings as appropriate. However, unnecessarily details may not be described. For example, the detailed description of already well-known matters and the overlapping description of approximately the same configurations may not be described. This is to avoid an unnecessarily redundant description below and to facilitate understanding by those skilled in the art.

Note that, the accompanying drawings and the following descriptions are provided to facilitate those skilled in the art to sufficiently understand the present disclosure, and are not intended to limit the subject matter described in the claims.

### First Exemplary Embodiment

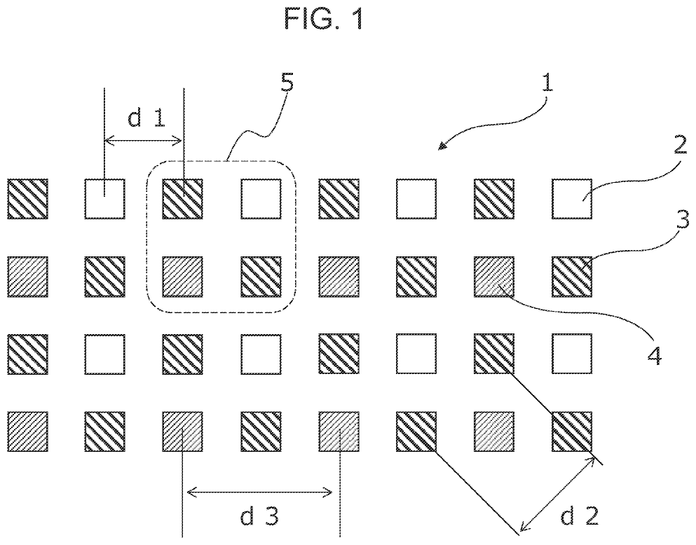

FIG. 1 is a partial top view of an antenna device according to a first exemplary embodiment of the present disclosure. FIG. 1 illustrates antenna device 1 that is a phased array antenna in the shape of a flat panel, for example. Antenna device 1 is also a multi-band antenna device corresponding to the Ka band or the Q band, for example.

FIG. 1 illustrates an example in which antenna device 1 is compatible with three frequency bands of a first frequency band, a second frequency band, and a third frequency band. A ratio of the first frequency band to the second frequency band to the third frequency band is approximately 2 to 3 to 4.

For simple description below, it is assumed that a ratio of the first frequency band to the second frequency band to the third frequency band is 2 to 3 to 4. For example, the first frequency band may be 20 GHz, the second frequency band may be 30 GHz, and the third frequency band may be 40 GHz.

As illustrated in FIG. 1, antenna device 1 includes first antenna elements 2, second antenna elements 3, and third antenna elements 4. First antenna element 2, second antenna element 3, and third antenna element 4 are each a patch antenna element and are disposed on a plane, for example.

First antenna element 2 corresponds to the third frequency band (transmits and/or receives a radio wave in the third frequency band). Second antenna element 3 corresponds to the second frequency band and the third frequency band. Third antenna element 4 corresponds to the first frequency band and the third frequency band. First antenna element 2, second antenna element 3, and third antenna element 4 may each be a two-polarization-compatible antenna element corresponding to two types of polarized waves.

FIG. 1 illustrates a dotted frame that indicates sub-array 5 of antenna elements. As illustrated in FIG. 1, sub-array 5 includes first antenna element 2 at the upper right, second antenna elements 3 at the upper left and the lower right, and third antenna element 4 at the lower left, for example. Antenna device 1 may be regarded as a two-dimensional array antenna in which sub-array 5 is repeatedly disposed in two-dimensional directions.

An interval between these antenna elements in sub-array 5 is a half wavelength of the third frequency band. For example, FIG. 1 illustrates an interval d1 that indicates the interval between these antenna elements in sub-arrays 5. The interval d1 is the half wavelength of the third frequency band.

Sub-array 5 includes first antenna elements 2, second antenna elements 3, and third antenna elements 4 that correspond to the third frequency band. Thus, these antenna elements in sub-arrays 5 disposed at intervals d1 allow the antenna elements corresponding to the third frequency band to be disposed in a lattice at an interval of the half wavelength of the third frequency band in the longitudinal direction and the lateral direction of FIG. 1.

Second antenna elements 3 have an interval that is 2^{1/2} times the interval between first antenna elements 2 and that is approximately a half wavelength (0.53 wavelength) of the second frequency band. For example, FIG. 1 illustrates an interval d2 that indicates the interval between second antenna elements 3. The interval d2 is approximately the half wavelength of the second frequency band. The interval d2 is 2^{1/2} times (2^{1/2} times d1) the interval between first antenna elements 2.

Sub-array 5 includes two second antenna elements 3 disposed in an oblique direction, the two second antenna elements 3 corresponding not only to the third frequency band but also to the second frequency band. Thus, the antenna elements in sub-arrays 5 disposed at the interval d1 allow the antenna elements corresponding to the second frequency band to be disposed in a lattice at an interval of the half wavelength of the second frequency band (interval d2 illustrated in FIG. 1) in an oblique direction (a direction at an angle of 45 degrees) of FIG. 1.

Third antenna elements 4 have an interval that is double the interval between first antenna elements 2 and that is a half wavelength of the first frequency band. For example, FIG. 1 illustrates an interval d3 that indicates the interval between third antenna elements 4. The interval d3 is the half wavelength of the first frequency band. The interval d3 is double the interval between first antenna elements 2 (two times d1).

Third antenna element 4, which is disposed at one of the four corners of sub-array 5, corresponds not only to the third frequency band but also to the first frequency band. Thus, the antenna elements in sub-arrays 5 disposed at the interval d1 allow the antenna elements corresponding to the first frequency band to be disposed in a lattice at an interval of the half wavelength of the first frequency band (interval d3 illustrated in FIG. 1) in the longitudinal direction and the lateral direction of FIG. 1.

Second antenna element 3 may be disposed at each of the upper right and lower left of sub-array 5 illustrated in FIG. 1. Alternatively, first antenna element 2 may be disposed at the lower left of sub-array 5 illustrated in FIG. 1, and third antenna element 4 may be disposed at the upper right thereof.

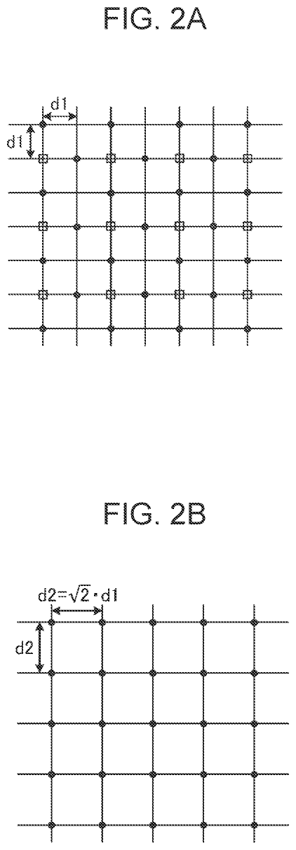

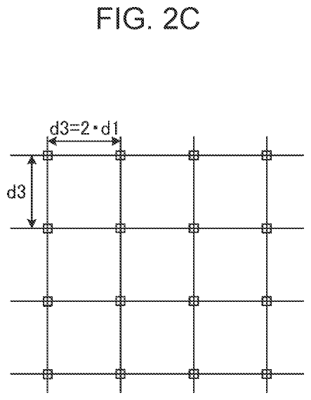

FIGS. 2A and 2B are each a diagram illustrating placement of antenna elements. FIG. 2A illustrates a lattice with an interval d1. The interval d1 is the half wavelength of the third frequency band.

FIG. 2B illustrates a lattice with an interval d2 that is 2^{1/2} times the interval d1. The second frequency band is ¾ times the third frequency band, and the interval d2 is approximately the half wavelength (0.53 wavelengths) of the second frequency band. The lattice in FIG. 2B has the interval 2^{1/2} times the interval d1 of the lattice illustrated in FIG. 2A, so that lattice points in FIG. 2B coincide with corresponding lattice points of black circles illustrated in FIG. 2A when the lattice in FIG. 2B is rotated 45 degrees.

Here, second antenna elements 3 corresponding to the second frequency band and the third frequency band are disposed at the lattice points of the black circles illustrated in FIG. 2A. Thus, the antenna elements corresponding to the second frequency band are disposed at the interval d2 of approximately the half wavelength of the second frequency band.

FIG. 2C illustrates a lattice with an interval d3 that is two times the interval d1. The first frequency band is ½ times the third frequency band, and the interval d3 is the half wavelength of the first frequency band. The lattice in FIG. 2C has an interval that is two times the interval d1 of the lattice illustrated in FIG. 2A, so that lattice points in FIG. 2C coincide with corresponding lattice points of squares illustrated in FIG. 2A without being rotated.

Here, third antenna elements 4 corresponding to the first frequency band and the third frequency band are disposed at the lattice points of the square illustrated in FIG. 2A. Thus, the antenna elements corresponding to the first frequency band are disposed at intervals d3 of the half wavelength of the first frequency band.

FIG. 2A illustrates the lattice with the interval d1 of the half wavelength of the third frequency band. First antenna elements 2 corresponding to the third frequency band are disposed at lattice points without indications of the black circles and the squares in FIG. 2A.

As described above, second antenna elements 3 corresponding to the second frequency band and the third frequency band, and third antenna elements 4 corresponding to the first frequency band and the third frequency band, are disposed at the lattice points of the black circles and the squares illustrated in FIG. 2A. Thus, the antenna elements corresponding to the third frequency band are disposed at the interval d1 of the half wavelength of the third frequency band.

That is, antenna device 1 includes the antenna elements corresponding to the first frequency band and being disposed uniformly (uniformly or at an equal interval on a square lattice) at the interval d3 of the half wavelength of the first frequency band. Antenna device 1 includes the antenna elements corresponding to the second frequency band and being uniformly disposed at the interval d2 of the half wavelength (approximately the half wavelength) of the second frequency band. Antenna device 1 includes the antenna elements corresponding to the third frequency band and being uniformly disposed at the interval d1 of the half wavelength of the third frequency band.

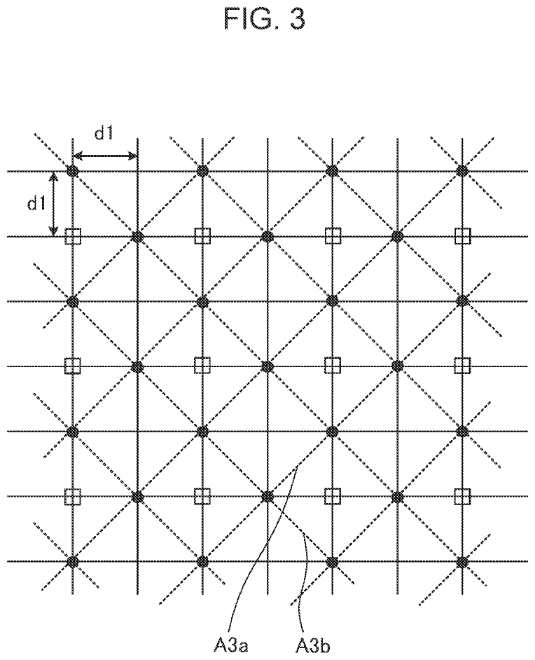

FIG. 3 is a diagram illustrating placement of antenna elements from another viewpoint. As in the above example, when the third frequency band is not an integral multiple of the second frequency band smaller than the third frequency band (the third frequency band is 4/3 times the second frequency band in the above example), the antenna elements corresponding to the second frequency band may be regarded as being disposed at an equal interval of the half wavelength (approximately the half wavelength) of the second frequency band, in a lattice including: a first lattice line that obliquely passes through lattice points of a lattice in which the antenna elements corresponding to the third frequency band are disposed at the respective lattice points; and a second lattice line perpendicular to the first lattice line.

For example, the antenna elements corresponding to the second frequency band are disposed in a lattice indicated by dotted lines A3a and A3b in FIG. 3 uniformly at an interval of approximately the half wavelength of the second frequency band. For example, second antenna elements 3 corresponding to the second frequency band are disposed at lattice points of the lattice indicated by dotted lines A3a and A3b, the lattice points each being indicated by a black circle in FIG. 3.

Dotted line A3a obliquely passes through a lattice point (intersection with solid lines illustrated in FIG. 3) at which the antenna element corresponding to the third frequency band is disposed. Dotted line A3b passes through a lattice point at which the antenna element corresponding to the third frequency band is disposed, and perpendicularly intersects with dotted line A3a. A lattice interval d (i.e., the interval d2 between second antenna elements 3) of the lattice indicated by dotted lines A3a and A3b is obtained by Formula (1) below.

d=(d1²+d1²)^{1/2}=2^{1/2}·d1 (1)

As described above, even when the third frequency band is not an integral multiple of the second frequency band smaller than the third frequency band, the antenna elements corresponding to the third frequency band are disposed at an interval of the half wavelength of the third frequency band, and the antenna elements corresponding to the second frequency band are disposed at an interval of the half wavelength (approximately the half wavelength) of the second frequency band.

When the third frequency band is an integral multiple of the first frequency band smaller than the third frequency band (the third frequency band is double the first frequency band in the above example), the antenna elements corresponding to the first frequency band are disposed at lattice points of a lattice where the antenna elements corresponding to the third frequency band are disposed.

For example, the antenna elements corresponding to the first frequency band are disposed in a lattice indicated by solid lines in FIG. 3 uniformly at an interval of the half wavelength of the first frequency band. For example, third antenna elements 4 corresponding to the first frequency band are disposed at squares illustrated in FIG. 3.

The above configuration allows a two-dimensional array antenna corresponding to the first frequency band, a two-dimensional array antenna corresponding to the second frequency band, and a two-dimensional array antenna corresponding to the third frequency band to be formed in one antenna aperture region instead of individual antenna apertures of the frequency bands. As a result, increase in size of antenna device 1 is suppressed.

Additionally, the antenna elements in the first frequency band, the second frequency band, and the third frequency band are each disposed at an interval of the half wavelength of the corresponding one of the frequency bands and are uniformly disposed. As a result, antenna device 1 can suppress deterioration of antenna characteristics such as frequency characteristics of gain, directional characteristics, and side lobe characteristics. Antenna device 1 also can achieve good beam control performance by suppressing deterioration of the antenna characteristics.

First antenna elements 2, second antenna elements 3, and third antenna elements 4 are formed on an antenna substrate that preferably has a relative dielectric constant of more than or equal to 3, for example, in consideration of downsizing of the antenna elements. For example, when the antenna substrate has a relative dielectric constant of about 4, third antenna element 4 can be reduced in size (e.g., length of one side of a quadrangular patch antenna) to about ¼ wavelength of the first frequency band. As a result, the antenna elements can be two-dimensionally disposed preventing first antenna element 2, second antenna element 3, and third antenna element 4 from overlapping each other.

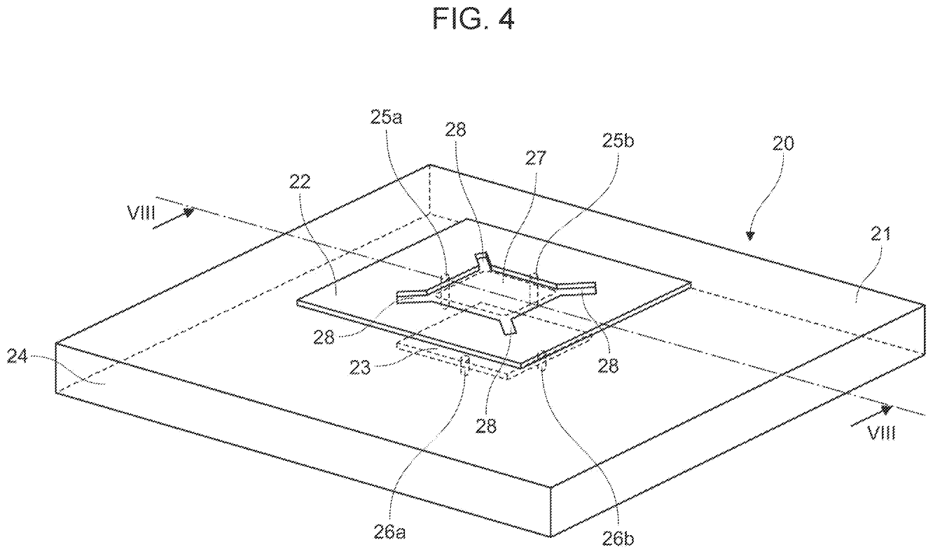

FIG. 4 is a perspective view of the second antenna element. As illustrated in FIG. 4, second antenna element 20 includes substrate 21, first antenna electrode 22, second antenna electrode 23, ground electrode 24, and feed through-holes 25a, 25b, 26a, 26b. Second antenna element 20 illustrated in FIG. 4 corresponds to second antenna element 3 illustrated in FIG. 1.

First antenna electrode 22 corresponds to the second frequency band. First antenna electrode 22 transmits and/or receives a radio wave in the second frequency band. First antenna electrode 22 is formed on substrate 21.

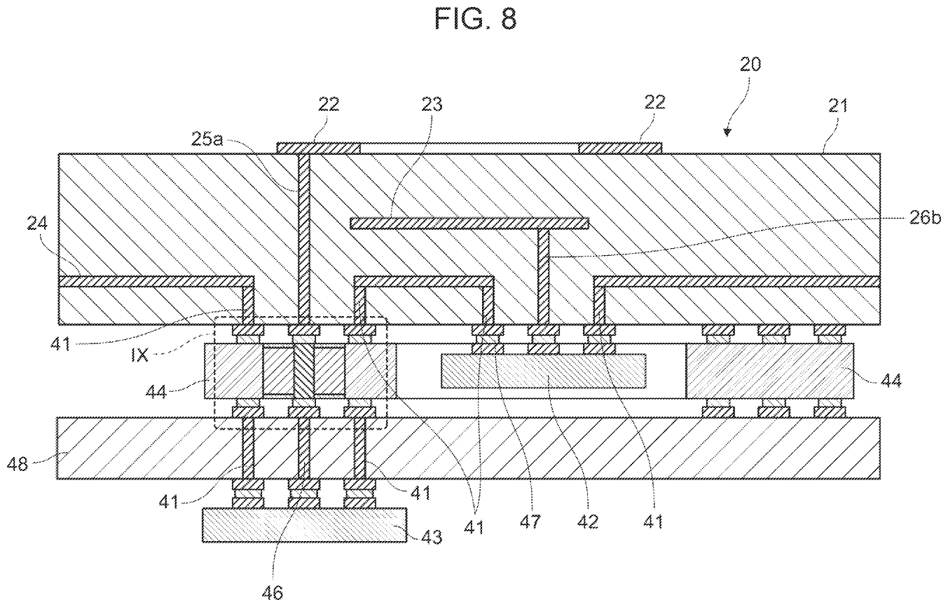

Second antenna electrode 23 corresponds to the third frequency band. Second antenna electrode 23 transmits and/or receives a radio wave in the third frequency band. Second antenna electrode 23 is formed in substrate 21 (e.g., see FIG. 8). Second antenna electrode 23 is formed between first antenna electrode 22 and ground electrode 24.

Ground electrode 24 is formed in substrate 21 (e.g., see FIG. 8). Ground electrode 24 is formed over the entire substrate 21, for example.

Feed through-holes 25a, 25b each allow first antenna electrode 22 to connect to a circuit corresponding to the second frequency band (a radio frequency integrated circuit (IC) to be described later). Feed through-holes 25a, 25b are used to supply power corresponding to linearly polarized waves that are orthogonal.

Feed through-holes 26a, 26b each allow second antenna electrode 23 to connect to a circuit corresponding to the third frequency band (a radio frequency IC to be described later). Feed through-holes 26a, 26b are used to supply power corresponding to linearly polarized waves that are orthogonal.

First antenna electrode 22 includes coupling adjustment elements 27, 28 (coupling adjustment elements 27, 28 are formed).

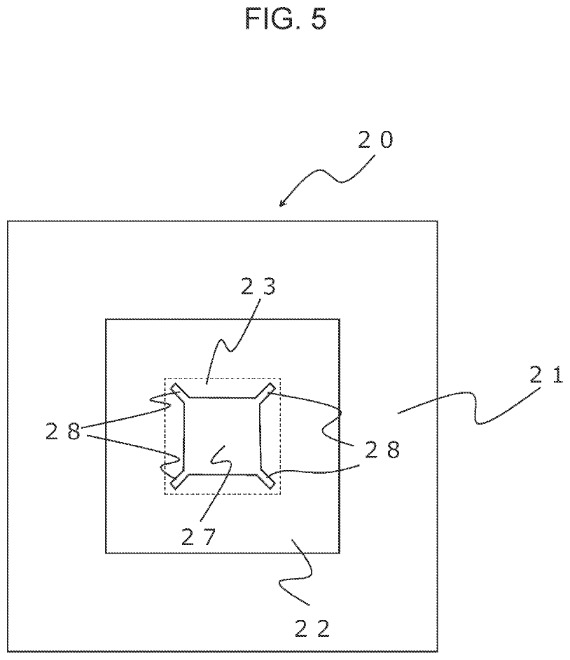

FIG. 5 is a top view of the second antenna element. FIG. 5 illustrates the same components as those in FIG. 4 with the same reference numerals as those in FIG. 4. First antenna electrode 22 includes coupling adjustment elements 27, 28.

Coupling adjustment element 27 includes a quadrangular hole formed in a center part of first antenna electrode 22. Coupling adjustment element 27 interrupts a current in a second harmonic mode or the like generated in first antenna electrode 22. As a result, spurious operation for third frequency band operation is suppressed.

Coupling adjustment element 28 includes slits formed at four corners of coupling adjustment element 27 in a quadrangular shape. Coupling adjustment element 28 interrupts a mode current or the like circulating through first antenna electrode 22. As a result, the spurious operation for the third frequency band operation is suppressed.

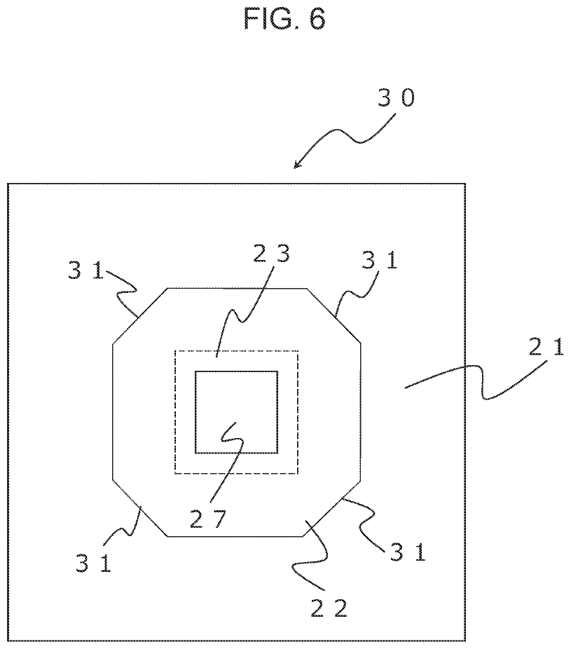

FIG. 6 is a top view of a second antenna element in another exemplary embodiment. FIG. 6 illustrates the same components as those in FIG. 5 with the same reference numerals as those in FIG. 5. Second antenna element 30 illustrated in FIG. 6 corresponds to second antenna element 3 illustrated in FIG. 1.

First antenna electrode 22 of second antenna element 30 includes coupling adjustment element 27. As with coupling adjustment element 27 described with reference to FIG. 5, coupling adjustment element 27 includes a quadrangular hole formed in a center part of first antenna electrode 22. Coupling adjustment element 27 interrupts a current in a second harmonic mode or the like generated in first antenna electrode 22. As a result, spurious operation for third frequency band operation is suppressed.

First antenna electrode 22 of second antenna element 30 includes coupling adjustment element 31. Coupling adjustment element 31 includes chamfers formed at four corners of first antenna electrode 22 in a quadrangular shape. Coupling adjustment element 31 interrupts a mode current or the like circulating through first antenna electrode 22. As a result, the spurious operation for the third frequency band operation is suppressed.

As described above, first antenna electrode 22 and second antenna electrode 23 are formed overlapping each other in one region (as viewed from above). Then, the first antenna electrode 22 is connected to a high frequency circuit of the second frequency band via feed through-holes 25a, 25b, and second antenna electrode 23 is connected to a high frequency circuit of the third frequency band via feed through-holes 26a, 26b. As a result, second antenna elements 20, 30 can operate in two frequency bands of the second frequency band and the third frequency band while sharing one region.

Second antenna elements 20, 30 also include corresponding coupling adjustment elements 27, 28, 31 that interrupt a current mode on the antenna electrode related to the spurious operation. As a result, second antenna elements 20, 30 can suppress mutual coupling between two frequency band operations and achieve good antenna element performance in frequency characteristics of gain, directional characteristics, and the like. The coupling adjustment element may be referred to as a coupling adjustment part.

Third antenna element 4 corresponding to the first frequency band and the third frequency band also has the same configuration as second antenna elements 20, 30 described above. For example, third antenna element 4 includes two antenna electrodes formed overlapping each other in one region. Each of the two antenna electrodes corresponds to the first frequency band and the third frequency band.

First antenna element 2 corresponding to the third frequency band includes one antenna electrode corresponding to the third frequency band, unlike second antenna element 3 and third antenna element 4 each including two antenna electrodes.

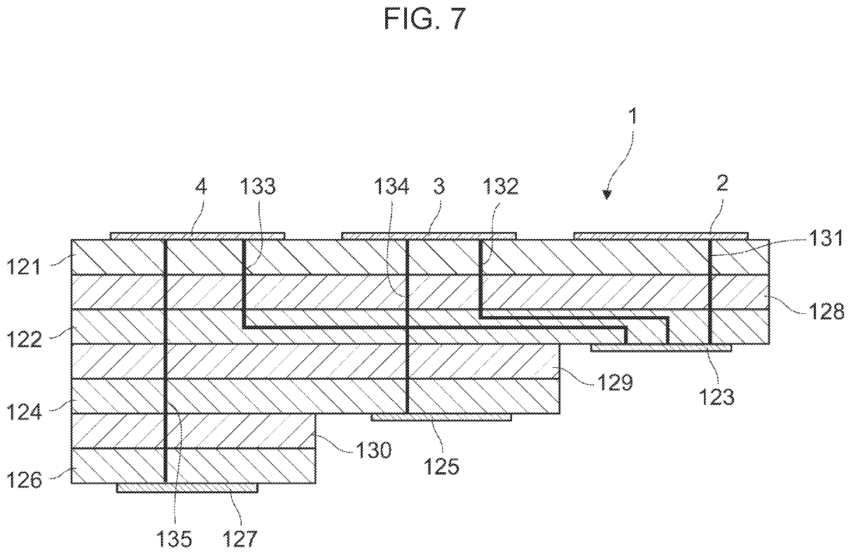

FIG. 7 is a sectional view of an antenna device including an antenna substrate, a high frequency circuit board, and an interposer. As illustrated in FIG. 7, antenna device 1 includes antenna substrate 121, high frequency circuit boards 122, 124, 126, high frequency ICs 123, 125, 127, interposers 128, 129, 130, and transmission lines 131, 132, 133, 134, 135.

Antenna substrate 121 has an upper surface on which first antenna element 2, second antenna element 3, and third antenna element 4 are disposed.

High frequency circuit board 122 is connected to antenna substrate 121 through a lower surface of antenna substrate 121 opposite to the upper surface on which first antenna element 2, second antenna element 3, and third antenna element 4 are disposed. High frequency circuit board 122 is connected to antenna substrate 121 with interposer 128 interposed therebetween. High frequency circuit board 122 corresponds to the first to third frequency bands, or transmits signals corresponding to the first to third frequency bands.

High frequency IC 123 is mounted on a second surface of high frequency circuit board 122 opposite to a first surface of high frequency circuit board 122 to which interposer 128 is connected. High frequency IC 123 processes a signal of the third frequency band.

High frequency circuit board 124 is connected to high frequency circuit board 122 through a second surface of high frequency circuit board 122 opposite to a first surface of high frequency circuit board 122 to which interposer 128 is connected. High frequency circuit board 124 is connected to high frequency circuit board 122 with interposer 129 interposed therebetween. High frequency circuit board 124 corresponds to the first frequency band and the second frequency band.

High frequency IC 125 is mounted on a second surface of high frequency circuit board 124 opposite to a first surface of high frequency circuit board 124 to which interposer 129 is connected. High frequency IC 125 processes a signal of the second frequency band.

High frequency circuit board 126 is connected to high frequency circuit board 124 through a second surface of high frequency circuit board 124 opposite to a first surface of high frequency circuit board 124 to which interposer 129 is connected. High frequency circuit board 126 is connected to high frequency circuit board 124 with interposer 130 interposed therebetween. High frequency circuit board 126 corresponds to the first frequency band.

High frequency IC 127 is mounted on a second surface of high frequency circuit board 126 opposite to a first surface of high frequency circuit board 126 to which interposer 130 is connected. High frequency IC 127 processes a signal of the first frequency band.

Interposer 128 includes a coaxial transmission line and transmits signals of the first frequency band, the second frequency band, and the third frequency band.

Interposer 129 includes a coaxial transmission line and transmits signals of the first frequency band and the second frequency band.

Interposer 130 includes a coaxial transmission line and transmits a signal of the first frequency band.

Transmission line 131 is used to transmit a signal of the third frequency band, the signal being transmitted and received between high frequency IC 123 and first antenna element 2. Transmission line 132 is used to transmit a signal of the third frequency band, the signal being transmitted between high frequency IC 123 and second antenna element 3. Transmission line 133 is used to transmit a signal of the third frequency band, the signal being transmitted between high frequency IC 123 and third antenna element 4.

Transmission line 134 is used to transmit a signal of the second frequency band, the signal being transmitted and received between high frequency IC 125 and second antenna element 3.

Transmission line 135 is used to transmit a signal of the first frequency band, the signal being transmitted and received between high frequency IC 127 and third antenna element 4.

Antenna substrate 121, interposer 128, high frequency circuit board 122, and transmission lines 131, 132, 133, which are vertically stacked, constitute a signal system of the third frequency band. Signals of the third frequency band transmitted and received between first antenna element 2, second antenna element 3, and third antenna element 4, and high frequency IC 123 are transmitted using the signal system of the third frequency band.

Antenna substrate 121, interposer 128, high frequency circuit board 122, interposer 129, high frequency circuit board 124, and transmission line 134, which are vertically stacked, constitute a signal system of the second frequency band. Signals of the second frequency band transmitted and received between second antenna element 3 and high frequency IC 125 are transmitted using the signal system of the second frequency band.

Antenna substrate 121, interposer 128, high frequency circuit board 122, interposer 129, high frequency circuit board 124, interposer 130, high frequency circuit board 126, and transmission line 135, which are vertically stacked, constitute a signal system of the first frequency band. Signals of the first frequency band transmitted and received between third antenna element 4 and high frequency IC 127 are transmitted using the signal system of the first frequency band.

Although high frequency IC 123 in an example of FIG. 7 is connected to three antenna elements of first antenna element 2, second antenna element 3, and third antenna element 4, high frequency IC 123 may be connected to four or more antenna elements. Although high frequency IC 125 is connected to one second antenna element 3, high frequency IC 125 may be connected to two or more second antenna elements 3. Although high frequency IC 127 is connected to one third antenna element 4, high frequency IC 127 may be connected to two or more third antenna elements 4.

FIG. 8 is a sectional view taken along line VIII-VIII in FIG. 4. Besides second antenna element 20 illustrated in FIG. 4, FIG. 8 illustrates ground through-hole 41, high frequency ICs 42, 43, interposer 44, signal through-hole 46, connection fixing material 47, and substrate 48.

Although FIG. 7 illustrates the example in which high frequency IC 123 corresponding to the third frequency band is disposed on a lower surface of high frequency circuit board 122, FIG. 8 illustrates an example in which high frequency IC 42 corresponding to the third frequency band is disposed on a lower surface of substrate 21 of second antenna element 20. Then, although FIG. 7 illustrates the example in which high frequency IC 123 corresponding to the third frequency band and interposer 128 are disposed in different layers, FIG. 8 illustrates the example in which high frequency IC 42 corresponding to the third frequency band and interposer 44 are disposed in the same layer. Antenna substrate 121 illustrated in FIG. 7 may be a substrate on which substrate 21 of second antenna element 20 illustrated in FIG. 4 is placed, may correspond to substrate 21 of second antenna element 20, or may be substrate 21.

Ground through-hole 41 is formed in substrates 21, 48. Ground through-hole 41 connects a ground of high frequency IC 42 mounted on substrate 21 and ground electrode 24 formed in substrate 21. Ground through-hole 41 also connects a ground of high frequency IC 43 mounted on substrate 48 and ground electrode 24 formed in substrate 21.

High frequency IC 42 corresponds to the third frequency band. High frequency IC 43 corresponds to the second frequency band.

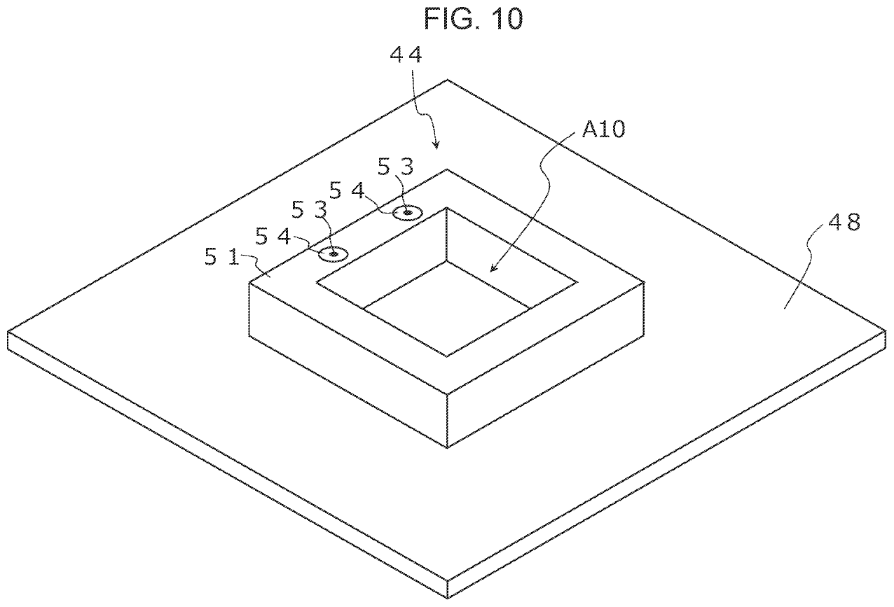

Interposer 44 electrically connects substrate 21 and substrate 48. For example, interposer 44 may have a frame shape surrounding high frequency IC 42 (e.g., see FIG. 10).

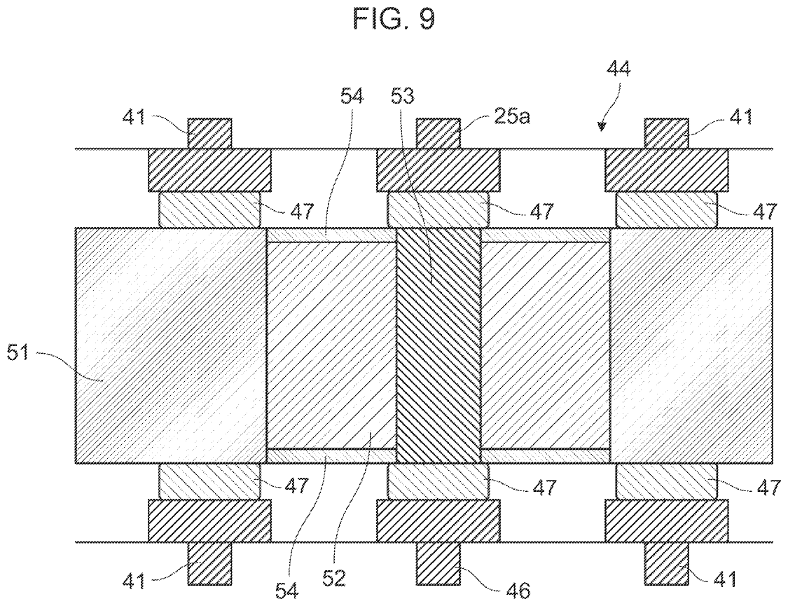

FIG. 9 is an enlarged view of dotted frame IX in FIG. 8. FIG. 9 illustrates the same components as those in FIG. 8 with the same reference numerals as those in FIG. 8. As illustrated in FIG. 9, interposer 44 includes body 51, coaxial insulator 52, coaxial transmission line 53, and holder 54.

Body 51 has a surface formed of a metal layer. Coaxial insulator 52 is a cavity formed in body 51. Coaxial insulator 52 may be made of an insulating material.

Coaxial transmission line 53 is formed passing through coaxial insulator 52. Coaxial transmission line 53 is formed excellent in high frequency characteristics by a metal layer (metal surface) on an inner surface of body 51 and coaxial insulator 52. Coaxial transmission line 53 is a conductor that transmits a signal of the second frequency band, and connects feed through-hole 25a and signal through-hole 46. Holder 54 is a member that holds coaxial transmission line 53 at the center of coaxial insulator 52.

FIG. 10 is a perspective view of an interposer. FIG. 10 also illustrates substrate 48 illustrated in FIG. 8 in addition to interposer 44. FIG. 10 illustrates the same components as those in FIG. 9 with the same reference numerals as those in FIG. 9.

As illustrated in FIG. 10, interposer 44 may have a frame shape. High frequency IC 42 illustrated in FIG. 8 may be disposed in a frame of interposer 44 indicated by arrow A10 in FIG. 10.

Interposer 44 is not limited to the quadrangular frame shape illustrated in FIG. 10. Interposer 44 may have a U-shape or a cube shape.

The description will be with reference to FIG. 8 again. Signal through-hole 46 is formed in substrate 48 and allows a signal of the second frequency band to be transmitted, the signal being transmitted and received between interposer 44 and high frequency IC 43.

Connection fixing material 47 electrically connects and fixes substrate 21, high frequency IC 42, interposer 44, substrate 48, and high frequency IC 43. Connection fixing material 47 may be solder, a conductive adhesive, or a conductive elastomer, for example.

As described above, antenna device 1 includes the antenna element, the high frequency circuit, and the high frequency IC that are connected to each other with the interposer interposed therebetween in a direction perpendicular to a plane on which the antenna element is formed. As a result, antenna device 1 includes the antenna element, the high frequency circuit board, and the high frequency IC that are disposed in layers, thereby suppressing an increase in size of the device.

Antenna device 1 also allows a difference in connection path length between the antenna element and the high frequency IC to be reduced, and thus enabling good high frequency characteristics to be achieved. Increase in frequency band causes an interval between the antenna elements to be narrowed with respect to a size of the high frequency IC, thereby causing the high frequency IC to occupy a larger area than the antenna element. For this matter, antenna device 1 allows the high frequency ICs to be disposed in layers, so that the area occupied by the high frequency IC is suppressed to suppress increase in size of antenna device 1. Antenna device 1 also enables preventing frequency characteristics from being narrowed because the antenna elements are disposed at half wavelength intervals suitable for a phased array antenna.

Additionally, antenna device 1 has a multilayer structure in which the antenna element, the high frequency circuit board, and the high frequency IC are layered with the interposer interposed therebetween, the interposer including the coaxial transmission line, so that a distance of the connection path between the antenna element and the high frequency IC is reduced to enable achieving good high frequency characteristics.

Interposer 129 illustrated in FIG. 7 may also have a frame shape as illustrated in FIG. 10. Then, high frequency IC 123 corresponding to the third frequency band may be disposed in the frame of interposer 129. Interposer 130 illustrated in FIG. 7 may also have a frame shape as illustrated in FIG. 10. Then, high frequency IC 125 corresponding to the second frequency band may be disposed in the frame of interposer 130.

### Summary of First Exemplary Embodiment

As described above, antenna device 1 includes first antenna elements 2 including antenna electrodes corresponding to third frequency band, second antenna elements 3 including second antenna electrodes 23 corresponding to the third frequency band, and third antenna elements 4 including antenna electrodes corresponding to the third frequency band; these antenna electrodes are disposed at lattice points at an interval d1 of half wavelength of the third frequency band. That is, antenna device 1 includes antenna electrodes corresponding to the third frequency band, and these antenna electrodes are disposed at the lattice points at the interval d1 of the half wavelength of the third frequency band.

Antenna device 1 includes second antenna elements 3 including first antenna electrodes 22 corresponding to the second frequency band; the first antenna electrodes 22 corresponding to the second frequency band are disposed at lattice points of an interval d2 in Formula (2) below.

d2={(n·d1)²+(m·d1)²}^{1/2} (2)

Here, n, m are positive integers and are selected so that the interval d2 is approximately the half wavelength (e.g., in a range from 0.5 wavelengths to 0.7 wavelengths, inclusive) of the second frequency band.

Antenna device 1 includes third antenna elements 4 including antenna electrodes corresponding to the first frequency band; the antenna electrodes corresponding to the first frequency band are disposed at lattice points of an integral multiple of the interval d1.

Then, second antenna electrodes 23 corresponding to the third frequency band of second antenna elements 3 and first antenna electrodes 22 corresponding to the second frequency band of second antenna elements 3 are disposed overlapping each other, and the antenna electrodes corresponding to the third frequency band of third antenna elements 4 and the antenna electrodes corresponding to the first frequency band of third antenna elements 4 are disposed overlapping each other.

As a result, the antenna electrodes corresponding to the three frequency bands can be uniformly disposed in one region at corresponding intervals of half wavelengths of respective frequency bands, and thus antenna device 1 suppresses not only increase in size of the device but also deterioration of antenna characteristics.

For example, a frequency ratio of the first frequency band to the second frequency band to the third frequency band is 2:3:4. The antenna electrodes corresponding to the third frequency band has the placement interval d1 set to the half wavelength of the third frequency band. When n, m are equal to 1, the interval d2 at which the antenna electrodes of the second frequency band are disposed is 2^{1/2}·d1 according to Formula (2), and thus is approximately a half wavelength (0.53 wavelength) of the second frequency band. Third antenna electrodes have an interval of 2·d1. In this case, the antenna electrodes corresponding to the three frequency bands are uniformly disposed in one region at corresponding intervals of half wavelengths of respective frequency bands (the antenna electrodes corresponding to the second frequency band have an interval of approximately a half wavelength, or 0.53 wavelengths), and thus antenna device 1 suppresses not only increase in size of the device but also deterioration of antenna characteristics.

<Variation>

Although antenna device 1 described above corresponds to three frequency bands, antenna device 1 may correspond to two frequency bands having a frequency ratio other than an integral multiple.

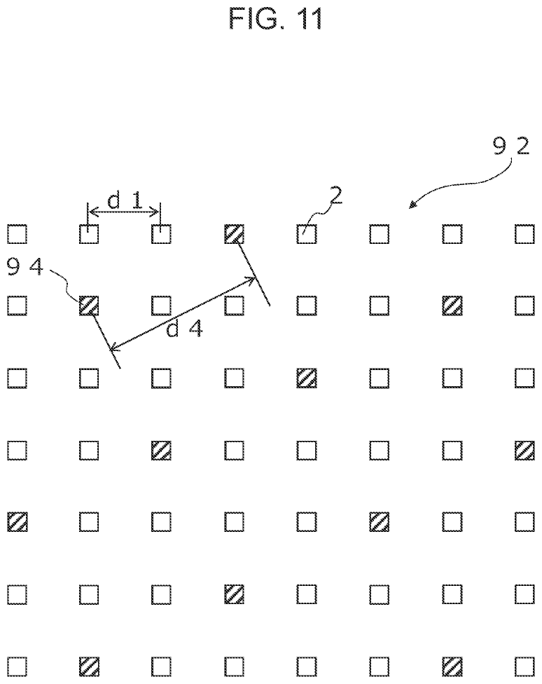

FIG. 11 is a diagram illustrating a modification of the antenna device according to the first exemplary embodiment. As illustrated in FIG. 11, antenna device 92 includes first antenna element 2 and fourth antenna element 94.

First antenna element 2 corresponds to a single third frequency band.

Fourth antenna element 94 corresponds to two frequency bands of the third frequency band and a fourth frequency band. Fourth antenna element 94 includes two antenna electrodes in the same manner as, for example, second antenna element 20 described with reference to FIG. 4, and corresponds to two frequency bands of the third frequency band and the fourth frequency band.

A ratio of the third frequency band to the fourth frequency band is approximately 4 to 1.8. For example, the third frequency band may be 40 GHz and the fourth frequency band may be 18 GHz. For simple description below, it is assumed that a ratio of the third frequency band to the fourth frequency band is 4 to 1.8.

First antenna elements 2 are disposed at the lattice points at interval d1. Interval d1 is the half wavelength of the third frequency band. However, since fourth antenna elements 94 also corresponds to the third frequency band, first antenna elements 2 are not disposed at the lattice points where fourth antenna elements 94 are disposed. For example, first antenna elements 2 are not disposed at positions of hatched squares illustrated in FIG. 11.

Fourth antenna elements 94 are disposed at the lattice points at an interval d4. The interval d4 is 5^{1/2} times the interval d1 of first antenna elements 2, and is approximately a half wavelength (0.503 wavelength) of the fourth frequency band (interval d4 is obtained by Formula (2) above where n is 2 and m is 1).

As described above, fourth antenna elements 94 correspond to the two frequency bands of the third frequency band and the fourth frequency band. Thus, the antenna elements corresponding to the third frequency band are uniformly disposed at the interval of the half wavelength of the third frequency band. The antenna elements corresponding to the fourth frequency band are uniformly disposed at the interval of approximately the half wavelength of the fourth frequency band. As a result, antenna device 92 can efficiently transmit and/or receive a radio wave in the third frequency band and a radio wave in the fourth frequency band.

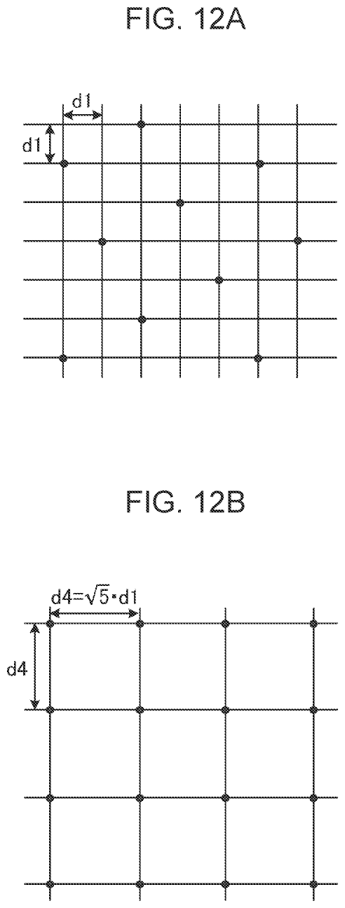

FIGS. 12A and 12B are each a diagram illustrating placement of antenna elements. FIG. 12A illustrates a lattice with an interval d1. The interval d1 is the half wavelength of the third frequency band.

FIG. 12B illustrates a lattice with an interval d4 that is 5^{1/2} times the interval d1. The fourth frequency band is 1.8/4 times the third frequency band, and the interval d4 is approximately the half wavelength (0.503 wavelengths) of the second frequency band. Since the lattice in FIG. 12B has the interval 5^{1/2} times the interval d1 of the lattice illustrated in FIG. 12A, lattice points in FIG. 12B coincide with corresponding lattice points of black circles illustrated in FIG. 12A when the lattice in FIG. 12B is rotated counterclockwise by about 27 degrees (sin⁻¹ (⅕^{1/2})).

Here, fourth antenna elements 94 corresponding to the third frequency band and the fourth frequency band are disposed at the lattice points of the black circles illustrated in FIG. 12A. Thus, the antenna elements corresponding to the fourth frequency band are disposed at the interval d4 of approximately the half wavelength of the fourth frequency band.

First antenna elements 2 corresponding to the third frequency band are disposed at lattice points without an indication of the black circle in FIG. 12A.

Here, fourth antenna elements 94 corresponding to the third frequency band and the fourth frequency band are disposed at the lattice points of the black circles illustrated in FIG. 12A as described above. Thus, the antenna elements corresponding to the third frequency band are disposed at the interval d1 of the half wavelength of the third frequency band.

That is, antenna device 92 includes the antenna elements corresponding to the third frequency band and being uniformly disposed at the interval d1 of the half wavelength of the third frequency band. Antenna device 92 includes the antenna elements corresponding to the fourth frequency band and being uniformly disposed at the interval d4 of the half wavelength (approximately the half wavelength) of the fourth frequency band.

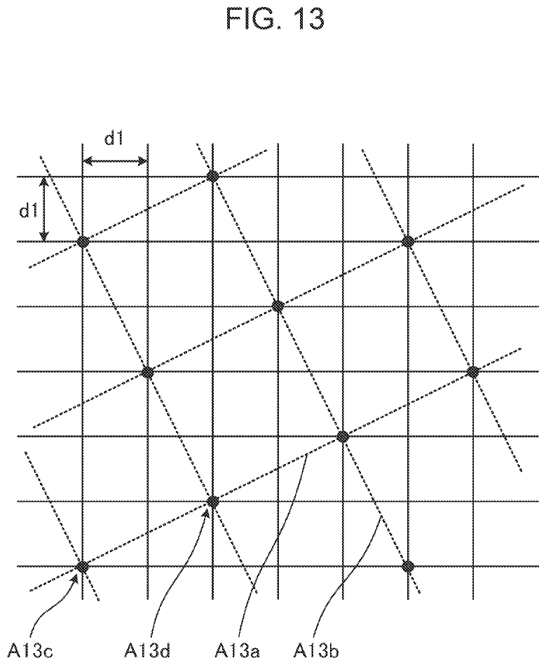

FIG. 13 is a diagram illustrating placement of antenna elements from another viewpoint. The fourth antenna elements 94 corresponding to the fourth frequency band may be regarded as being disposed at equal intervals of the half wavelength (approximately the half wavelength) of the fourth frequency band in a lattice including: a first lattice line that obliquely passes through lattice points of a lattice in which the antenna elements corresponding to the third frequency band are disposed at the respective lattice points; and a second lattice line perpendicular to the first lattice line.

For example, the antenna elements corresponding to the fourth frequency band are disposed in a lattice indicated by dotted lines A13a and A13b in FIG. 13 uniformly at an interval of approximately the half wavelength of the fourth frequency band. For example, fourth antenna elements 94 corresponding to the fourth frequency band are disposed at lattice points of the lattice of a first lattice line indicated by dotted line A13a and a second lattice line indicated by dotted line A13b, the lattice points each being indicated by a black circle in FIG. 13.

The first lattice line indicated by dotted line A13a passes through a first lattice point (see arrow A13c in FIG. 13) of the lattice at which the antenna element corresponding to the third frequency band is disposed. The first lattice line indicated by dotted line A13a also passes through a second lattice point (see arrow A13d in FIG. 13) displaced by 2·d1 in a horizontal direction and displaced by 1·d1 in a vertical direction with respect to the first lattice point.

In this manner, antenna device 92 is compatible with two frequency bands having a frequency ratio other than an integral multiple.

The first lattice line may pass through not only the first lattice point of the lattice at which the antenna element corresponding to the third frequency band is disposed, but also the second lattice point displaced by n·d1 in the horizontal direction and m·d1 in the vertical direction with respect to the first lattice point. Changing values of n, m enables the antenna device to correspond to various frequency bands having a ratio of a non-integral multiple. For example, n may be 3 and m may be 1. The first lattice line of antenna device 1 illustrated in FIG. 1 has n being 1 and m being 1 (e.g., see FIG. 3 and Formula (1)).

### Second Exemplary Embodiment

The first exemplary embodiment allows one antenna element to correspond to two frequency bands. For example, second antenna element 3 corresponds to the second frequency band and the third frequency band, and third antenna element 4 corresponds to the first frequency band and the third frequency band. The second exemplary embodiment allows one antenna element to correspond to one frequency band.

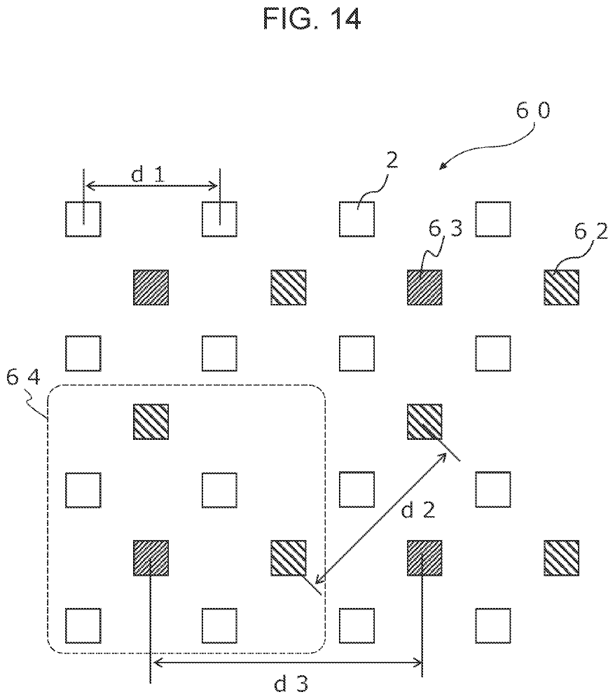

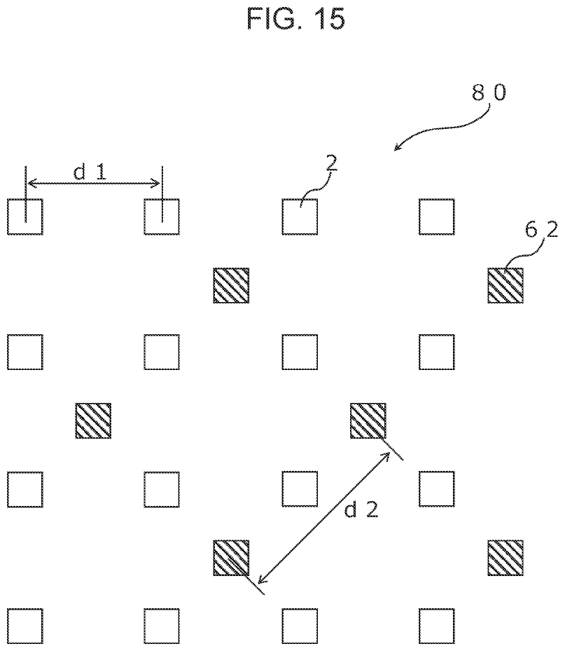

FIG. 14 is a partial top view of an antenna device according to the second exemplary embodiment of the present disclosure. FIG. 14 illustrates the same components as those in FIG. 1 with the same reference numerals as those in FIG. 1.

As illustrated in FIG. 14, antenna device 60 includes first antenna element 2 corresponding to the third frequency band, second antenna element 62 corresponding to the second frequency band, and third antenna element 63 corresponding to the first frequency band. First antenna element 2, second antenna element 62, and third antenna element 63 are uniformly disposed without overlapping each other.

A ratio of the first frequency band to the second frequency band to the third frequency is approximately 2 to 3 to 4. For simple description below, it is assumed that a ratio of the first frequency band to the second frequency band to the third frequency band is 2 to 3 to 4.

First antenna element 2 is disposed at the lattice point at an interval d1. The interval d1 is the half wavelength of the third frequency band.

Second antenna element 62 is disposed at the lattice point at an interval d2. The interval d2 is 2^{1/2} times the interval d1 between first antenna elements 2 and is approximately a half wavelength (0.53 wavelength) of the second frequency band. As a result, antenna device 60 can efficiently transmit and/or receive a radio wave in the third frequency band and a radio wave in the fourth frequency band, a frequency band ratio of the third frequency band to the fourth frequency band being 3:4.

Third antenna element 63 is disposed at the lattice point at an interval d3. The interval d3 is two times the interval d1 between first antenna elements 2 and is the half wavelength of the first frequency band. As a result, antenna device 60 can efficiently transmit and/or receive a radio wave in the first frequency band and a radio wave in the third frequency band, a frequency band ratio of the first frequency band to the third frequency band being 1:2.

FIG. 14 illustrates a dotted frame that indicates sub-array 64 of antenna elements. As illustrated in FIG. 14, sub-array 64 includes four first antenna elements 2 in a lower left part, for example. Sub-array 64 includes third antenna element 63 at the center of four surrounding first antenna elements 2. Sub-array 64 also includes second antenna elements 62 at an upper part and at a right part of third antenna element 63. Antenna device 60 may be regarded as a two-dimensional array antenna in which sub-array 64 is repeatedly disposed in two-dimensional directions.

Second antenna elements 62 illustrated in FIG. 14 may be regarded as being disposed at respective lattice points (at respective black circles in FIG. 2B) of a lattice obtained by rotating the lattice with interval d2 illustrated in FIG. 2B by 45 degrees. Then, second antenna elements 62 disposed at the respective lattice points of the lattice rotated by 45 degrees may be regarded as being disposed without overlapping first antenna elements 2 as illustrated in FIG. 14. For example, one second antenna element 62 may be regarded as being disposed at the center of four surrounding first antenna elements 2 adjacent to each other.

Third antenna elements 63 illustrated in FIG. 14 may be regarded as being disposed at respective lattice points (at respective squares in FIG. 2C) of the lattice with interval d3 illustrated in FIG. 2C. Then, third antenna elements 63 may be regarded as being disposed without overlapping first antenna elements 2 and second antenna elements 62 as illustrated in FIG. 14. For example, one third antenna element 63 may be regarded as being disposed at the center of not only four surrounding first antenna elements 2 adjacent to each other, but also four surrounding second antenna elements 62 adjacent to each other.

When the third frequency band is not an integral multiple of the second frequency band smaller than the third frequency band (the third frequency band is 4/3 times the second frequency band in the above example), the antenna elements corresponding to the second frequency band may be regarded being disposed at equal intervals of the half wavelength (approximately the half wavelength) of the second frequency band in a lattice including: a first lattice line that obliquely passes through lattice points of a lattice in which the antenna elements corresponding to the third frequency band are disposed at the respective lattice points; and a second lattice line perpendicular to the first lattice line. However, the lattice points of the lattice including the first lattice line and the second lattice line are disposed without overlapping the lattice points of the lattice in which the antenna elements corresponding to the third frequency band are disposed.

Antenna device 60 with the above configuration includes the antenna elements corresponding to the first frequency band and being uniformly disposed at intervals d3 of the half wavelength of the first frequency band. Antenna device 60 includes the antenna elements corresponding to the second frequency band and being uniformly disposed at an interval d2 of the half wavelength (approximately the half wavelength) of the second frequency band. Antenna device 60 also includes the antenna elements corresponding to the third frequency band and being uniformly disposed at an interval d1 of the half wavelength of the third frequency band.

First antenna elements 2, second antenna elements 62, and third antenna elements 63 are formed on substrate using a relative dielectric constant that allows the first, second, and third antenna elements to be sufficiently small in size with respect to intervals d1, d2, d3. Although not described, the multilayer structure described in the first exemplary embodiment is also applied to antenna device 60 of the second exemplary embodiment.

### Summary of Second Exemplary Embodiment

As described above, antenna device 1 includes first antenna elements 2 with the antenna electrodes corresponding to the third frequency band and being disposed at the lattice points at the interval d1 of the half wavelength of the third frequency band.

Antenna device 1 also includes second antenna elements 62 with the antenna electrodes corresponding to the second frequency band and being disposed at the lattice points of interval d2 represented by Formula (2) above.

Antenna device 1 includes the antenna electrodes corresponding to the first frequency band of third antenna elements 63 and being disposed at the lattice points of an integral multiple of interval d1.

Second antenna element 62 includes an antenna electrode corresponding to the second frequency band and being disposed at the center of four surrounding antenna electrodes of first antenna element 2, the four surrounding antenna electrodes being close to the antenna electrode.

Third antenna element 63 includes an antenna electrode corresponding to the first frequency band and being disposed at the center of four surrounding antenna electrodes of first antenna element 2, the four surrounding antenna electrodes being close to the antenna electrode, and the antenna electrode corresponding to the first frequency band is disposed without overlapping the antenna electrode of second antenna element 62.

As a result, the antenna electrodes corresponding to the three frequency bands can be uniformly disposed in one region at corresponding intervals of half wavelengths of respective frequency bands, and thus antenna device 1 suppresses not only increase in size of the device but also deterioration of antenna characteristics.

### First Modification

Although antenna device 60 described with reference to FIG. 14 corresponds to three frequency bands, antenna device 60 may correspond to two frequency bands having a frequency ratio other than an integral multiple.

FIG. 15 is a diagram illustrating a first modification of the antenna device according to the second exemplary embodiment. FIG. 15 illustrates the same components as those in FIG. 14 with the same reference numerals as those in FIG. 14.

As illustrated in FIG. 15, antenna device 80 includes first antenna element 2 and second antenna element 62. Antenna device 80 does not include third antenna element 63 illustrated in FIG. 14.

In this manner, antenna device 80 can achieve good antenna characteristics even for two frequency bands having a frequency ratio other than an integral multiple.

Second Modification

Although two frequency bands having a frequency ratio other than an integral multiple have a frequency ratio of 3 to 4 in the above description, the frequency ratio is not limited thereto.

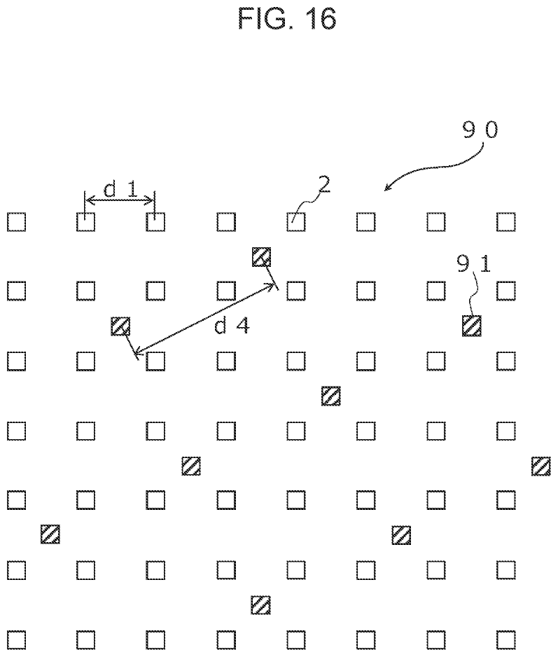

FIG. 16 is a diagram illustrating a second modification of the antenna device according to the second exemplary embodiment. As illustrated in FIG. 16, antenna device 90 includes first antenna element 2 and fourth antenna element 91.

First antenna element 2 corresponds to the third frequency band. Fourth antenna element 91 corresponds to the fourth frequency band.

A ratio of the third frequency band to the fourth frequency band is approximately 4 to 1.8. For example, the third frequency band may be 40 GHz and the fourth frequency band may be 18 GHz. For simple description below, it is assumed that a ratio of the third frequency band to the fourth frequency band is 4 to 1.8.

First antenna element 2 is disposed at the lattice point at an interval d1. The interval d1 is the half wavelength of the third frequency band.

Fourth antenna element 91 is disposed at the lattice point at an interval d4. The interval d4 is 5^{1/2} times the interval d1 between first antenna elements 2 and is approximately a half wavelength (0.503 wavelength) of the fourth frequency band. Fourth antenna element 94 is disposed at the center of four surrounding first antenna elements 2 adjacent to each other.

Fourth antenna element 91 may be regarded as being disposed at the lattice point obtained by rotating the lattice illustrated in FIG. 12B counterclockwise by about 27 degrees and being positioned at the center of four surrounding lattice points of the lattice at the interval d1 illustrated in FIG. 12A.

Fourth antenna element 91 may be regarded as being disposed on a lattice point of a lattice obtained by translating the lattice indicated by dotted line A13a and dotted line A13b in FIG. 13. The lattice indicated by dotted line A13a and dotted line A13b is translated with its lattice point to be located at the center of four surrounding lattice points of the lattice with interval d1 (lattice indicated by solid lines).

In this manner, antenna device 90 is compatible with two frequency bands having a frequency ratio other than an integral multiple.

The exemplary embodiments have been described above with reference to the drawings. The ratio of the frequency bands described above may be determined allowing an interval between the antenna elements to be within a range from 0.5 wavelength (half wavelength) to 0.7 wavelength inclusive, for example. Then, the frequency band may be simply referred to as a frequency.

Additionally, the present disclosure is not limited to the examples described above. Those skilled in the art can clearly and easily conceive of various changes or modifications within the scope of claims. Such changes or modifications are also understood to belong to the technical scope of the present disclosure. Within a range without departing from the gist of the present disclosure, the components in the exemplary embodiments may be combined as appropriate.

The expression, “ . . . part”, used for each component in the above-described exemplary embodiments may be replaced with another expression such as “ . . . circuit (circuitry)”, “ . . . assembly”, “ . . . device”, “ . . . unit”, or “ . . . module”.

Techniques disclosed in the exemplary embodiments and the modifications of the exemplary embodiments may be specified by items below.

[Item 1] An antenna device including: a plurality of first antenna electrodes corresponding to a first frequency; and a plurality of second antenna electrodes corresponding to a second frequency lower than the first frequency, wherein each of the first antenna electrodes is disposed at a different one of lattice points at an interval of a half wavelength of the first frequency, and each of the second antenna electrodes is disposed at a different one of lattice points at an interval represented by the formula

{(n·d)²+(m·d)²}^{1/2},

where d is the half wavelength of the first frequency, and n and m are positive integers.

[Item 2] The antenna device according to item 1, wherein each of the second antenna electrodes overlaps with a different one of the first antenna electrodes in plan view.

[Item 3] The antenna device according to item 2, wherein each of the second antenna electrodes includes a coupling adjustment element that suppresses a spurious operation at the first frequency.

[Item 4] The antenna device according to item 1, wherein each of the second antenna electrodes is disposed at a center of an area surrounded by four first antenna electrodes of the first antenna electrodes, the four first antenna electrodes being adjacent to a corresponding one of the second antenna electrodes.

[Item 5] The antenna device according to item 1, wherein a frequency ratio of the first frequency to the second frequency is approximately 4:3.

[Item 6] The antenna device according to item 5, wherein n and m are each 1.

[Item 7] The antenna device according to item 1, wherein a frequency ratio of the first frequency to the second frequency is approximately 4:1.8.

[Item 8] The antenna device according to item 7, wherein n is 2, and m is 1.

[Item 9] The antenna device according to item 1, further including: an antenna substrate having a first surface and a second surface, the first surface and the second surface being disposed in such a manner that the first antenna electrodes and the second antenna electrodes are closer to the first surface than the second surface; a first substrate disposed closer to the second surface of the antenna substrate than the first surface of the antenna substrate, the first substrate having a surface and another surface, the surface of the first substrate and the another surface of the first substrate being disposed in such a manner that the antenna substrate is closer to the surface of the first substrate than the another surface of the first substrate, the first substrate corresponding to the first frequency and the second frequency; a second substrate disposed closer to the another surface of the first substrate than the surface of the first substrate, the second substrate having a surface and another surface, the surface of the second substrate and the another surface of the second substrate being disposed in such a manner that the first substrate is closer to the surface of the second substrate than the another surface of the second substrate, the second substrate corresponding to the second frequency; a first interposer disposed between the antenna substrate and the first substrate, the first interposer including a coaxial transmission line to transmit a signal corresponding to the first frequency and a signal corresponding to the second frequency; a second interposer disposed between the first substrate and the second substrate, the second interposer including a coaxial transmission line to transmit a signal corresponding to the second frequency; a first circuit disposed on the another surface of the first substrate, the first circuit being configured to process a signal corresponding to the first frequency; and a second circuit disposed on the another surface of the second substrate, the second circuit being configured to process a signal corresponding to the second frequency.

[Item 10] The antenna device according to item 1, further including a plurality of third antenna electrodes corresponding to a third frequency lower than the second frequency, the third antenna electrodes each being disposed at different one of lattice points at an interval of an integral multiple of the half wavelength of the first frequency.

[Item 11] The antenna device according to item 10, wherein each of the third antenna electrodes overlaps with a different one of the first antenna electrodes in plan view.

[Item 12] The antenna device according to item 10, wherein each of the third antenna electrodes includes a coupling adjustment element that suppresses a spurious operation at the first frequency.

[Item 13] The antenna device according to item 10, wherein each of the third antenna electrodes is disposed at a center of an area surrounded by four first antenna electrodes of the first antenna electrodes, the four first antenna electrodes being adjacent to a corresponding one of the third antenna electrodes, the third antenna electrodes being free of overlap with the second antenna electrodes in plan view.

[Item 14] The antenna device according to item 10, wherein a frequency ratio of the first frequency to the second frequency to the third frequency is approximately 4:3:2.

[Item 15] The antenna device according to item 14, wherein n and m are each 1, and each of the third antenna electrodes is disposed at a different one of lattice points at an interval of double the half wavelength of the first frequency.

[Item 16] The antenna device according to item 10, further including: an antenna substrate having a first surface and a second surface, the first surface and the second surface being disposed in such a manner that the first antenna electrodes, the second antenna electrodes, and the third antenna electrodes are closer to the first surface than the second surface; a first substrate disposed closer to the second surface of the antenna substrate than the first surface of the antenna substrate, the first substrate having a surface and another surface, the surface of the first substrate and the another surface of the first substrate being disposed in such a manner that the antenna substrate is closer to the surface of the first substrate than the another surface of the first substrate, the first substrate corresponding to the first frequency, the second frequency, and the third frequency; a second substrate disposed closer to the another surface of the first substrate than the surface of the first substrate, the second substrate having a surface and another surface, the surface of the second substrate and the another surface of the second substrate being disposed in such a manner that the first substrate is closer to the surface of the second substrate than the another surface of the second substrate, the second substrate corresponding to the second frequency and the third frequency; a third substrate disposed closer to the another surface of the second substrate than the surface of the second substrate, the third substrate having a surface and another surface, the surface of the third substrate and the another surface of the third substrate being disposed in such a manner that the second substrate is closer to the surface of the third substrate than the another surface of the third substrate, the third substrate corresponding to the third frequency; a first interposer disposed between the antenna substrate and the first substrate, the first interposer including a coaxial transmission line to transmit a signal corresponding to the first frequency, a signal corresponding to the second frequency, and a signal corresponding to the third frequency; a second interposer disposed between the first substrate and the second substrate, the second interposer including a coaxial transmission line to transmit a signal corresponding to the second frequency and a signal corresponding to the third frequency; a third interposer disposed between the second substrate and the third substrate, the third interposer including a coaxial transmission line to transmit a signal corresponding to the third frequency; a first circuit disposed on the another surface of the first substrate, the first circuit being configured to process a signal corresponding to the first frequency; a second circuit disposed on the another surface of the second substrate, the second circuit being configured to process a signal corresponding to the second frequency; and a third circuit disposed on the another surface of the third substrate, the third circuit being configured to process a signal corresponding to the third frequency.

The antenna device according to the present disclosure has an effect of suppressing an increase in size of a phased array antenna device compatible with a plurality of frequency bands, and is useful as a phased array antenna device in the shape of a flat panel for a multi-band communication device. The antenna device is also applicable to applications of antenna devices of a multiband mobile communication system, a satellite communication system, a multiband portable wireless station, a multiband radar, and the like.

What is claimed is:

1. An antenna device comprising:
a plurality of first antenna electrodes corresponding to a first frequency; and
a plurality of second antenna electrodes corresponding to a second frequency lower than the first frequency, wherein
each of the first antenna electrodes is disposed at a different one of lattice points at an interval of a half wavelength of the first frequency, and
each of the second antenna electrodes is disposed at a different one of lattice points at an interval represented by the formula
{(n·d)²+(m·d)²}^{1/2},
where d is the half wavelength of the first frequency, and n and m are positive integers.

2. The antenna device according to claim 1, wherein each of the second antenna electrodes overlaps with a different one of the first antenna electrodes in plan view.

3. The antenna device according to claim 2, wherein each of the second antenna electrodes includes a coupling adjustment element that suppresses a spurious operation at the first frequency.

4. The antenna device according to claim 1, wherein each of the second antenna electrodes is disposed at a center of an area surrounded by four first antenna electrodes of the first antenna electrodes, the four first antenna electrodes being adjacent to a corresponding one of the second antenna electrodes.

5. The antenna device according to claim 1, wherein a frequency ratio of the first frequency to the second frequency is approximately 4:3.

6. The antenna device according to claim 5, wherein n and m are each 1.

7. The antenna device according to claim 1, wherein a frequency ratio of the first frequency to the second frequency is approximately 4:1.8.

8. The antenna device according to claim 7, wherein n is 2, and m is 1.

9. The antenna device according to claim 1, further comprising:
an antenna substrate having a first surface and a second surface, the first surface and the second surface being disposed in such a manner that the first antenna electrodes and the second antenna electrodes are closer to the first surface than the second surface;
a first substrate disposed closer to the second surface of the antenna substrate than the first surface of the antenna substrate, the first substrate having a surface and another surface, the surface of the first substrate and the another surface of the first substrate being disposed in such a manner that the antenna substrate is closer to the surface of the first substrate than the another surface of the first substrate, the first substrate corresponding to the first frequency and the second frequency;
a second substrate disposed closer to the another surface of the first substrate than the surface of the first substrate, the second substrate having a surface and another surface, the surface of the second substrate and the another surface of the second substrate being disposed in such a manner that the first substrate is closer to the surface of the second substrate than the another surface of the second substrate, the second substrate corresponding to the second frequency;
a first interposer disposed between the antenna substrate and the first substrate, the first interposer including a coaxial transmission line to transmit a signal corresponding to the first frequency and a signal corresponding to the second frequency;
a second interposer disposed between the first substrate and the second substrate, the second interposer including a coaxial transmission line to transmit a signal corresponding to the second frequency;
a first circuit disposed on the another surface of the first substrate, the first circuit being configured to process a signal corresponding to the first frequency; and
a second circuit disposed on the another surface of the second substrate, the second circuit being configured to process a signal corresponding to the second frequency.

10. The antenna device according to claim 1, further comprising a plurality of third antenna electrodes corresponding to a third frequency lower than the second frequency, the third antenna electrodes each being disposed at different one of lattice points at an interval of an integral multiple of the half wavelength of the first frequency.

11. The antenna device according to claim 10, wherein each of the third antenna electrodes overlaps with a different one of the first antenna electrodes in plan view.

12. The antenna device according to claim 10, wherein each of the third antenna electrodes includes a coupling adjustment element that suppresses a spurious operation at the first frequency.

13. The antenna device according to claim 10, wherein each of the third antenna electrodes is disposed at a center of an area surrounded by four first antenna electrodes of the first antenna electrodes, the four first antenna electrodes being adjacent to a corresponding one of the third antenna electrodes, the third antenna electrodes being free of overlap with the second antenna electrodes in plan view.

14. The antenna device according to claim 10, wherein a frequency ratio of the first frequency to the second frequency to the third frequency is approximately 4:3:2.

15. The antenna device according to claim 14, wherein
n and m are each 1, and
each of the third antenna electrodes is disposed at a different one of lattice points at an interval of double the half wavelength of the first frequency.

16. The antenna device according to claim 10, further comprising:
an antenna substrate having a first surface and a second surface, the first surface and the second surface being disposed in such a manner that the first antenna electrodes, the second antenna electrodes, and the third antenna electrodes are closer to the first surface than the second surface;
a first substrate disposed closer to the second surface of the antenna substrate than the first surface of the antenna substrate, the first substrate having a surface and another surface, the surface of the first substrate and the another surface of the first substrate being disposed in such a manner that the antenna substrate is closer to the surface of the first substrate than the another surface of the first substrate, the first substrate corresponding to the first frequency, the second frequency, and the third frequency;
a second substrate disposed closer to the another surface of the first substrate than the surface of the first substrate, the second substrate having a surface and another surface, the surface of the second substrate and the another surface of the second substrate being disposed in such a manner that the first substrate is closer to the surface of the second substrate than the another surface of the second substrate, the second substrate corresponding to the second frequency and the third frequency;
a third substrate disposed closer to the another surface of the second substrate than the surface of the second substrate, the third substrate having a surface and another surface, the surface of the third substrate and the another surface of the third substrate being disposed in such a manner that the second substrate is closer to the surface of the third substrate than the another surface of the third substrate, the third substrate corresponding to the third frequency;
a first interposer disposed between the antenna substrate and the first substrate, the first interposer including a coaxial transmission line to transmit a signal corresponding to the first frequency, a signal corresponding to the second frequency, and a signal corresponding to the third frequency;
a second interposer disposed between the first substrate and the second substrate, the second interposer including a coaxial transmission line to transmit a signal corresponding to the second frequency and a signal corresponding to the third frequency;
a third interposer disposed between the second substrate and the third substrate, the third interposer including a coaxial transmission line to transmit a signal corresponding to the third frequency;
a first circuit disposed on the another surface of the first substrate, the first circuit being configured to process a signal corresponding to the first frequency;
a second circuit disposed on the another surface of the second substrate, the second circuit being configured to process a signal corresponding to the second frequency; and
a third circuit disposed on the another surface of the third substrate, the third circuit being configured to process a signal corresponding to the third frequency.
